(19) United States
(12) Patent Application Publication
(10) Pub. No.: US 2019/0253594 A1
(43) Pub. Date: Aug. 15, 2019

(54) Imaging Camera

(71) Applicant: AAC Technologies Pte. Ltd., Singapore city (SG)

(72) Inventor: Chuandong Wei, Shenzhen (CN)

(21) Appl. No.: 16/236,312

(22) Filed: Dec. 28, 2018

(30) Foreign Application Priority Data
Feb. 9, 2018 (CN) 201820249500.2

(51) Int. Cl. H04N 5/225

(52) U.S. Cl. CPC H04N 5/22521; H04N 5/2254

(57) ABSTRACT

The present application discloses an imaging camera, including: a lens holder with an aperture; and a shielding located at an object side of the lens holder and connected to the lens holder. The shielding is coaxial with the lens holder. The shielding includes an opening communicated with the aperture, and the opening has a diameter gradually reduced along a direction from the object side to an image side.

### FIELD OF THE PRESENT DISCLOSURE

The present disclosure relates to the field of image capturing, and more particularly to an imaging camera for capturing an image.

### DESCRIPTION OF RELATED ART

With development of technology, besides digital cameras, more and more portable electronic devices are equipped with image capturing functions. To achieve the image capturing function, a camera module is needed. Generally, a camera module includes a camera lens for collecting light reflected from an object, a sensor for receiving the light and converting the light to electrical signals, and processor for calculating the signals and outputting digital images.

A related imaging camera generally includes a lens holder and a plurality of lens units accommodated in the lens holder. For positioning the lens holder, the imaging camera further provides a housing for accommodating and fastening the lens holder. One important trend of imaging camera is to make the camera smaller, thinner but get more excellent image quality.

Therefore, it is desired that an improved imaging camera can satisfy the trend mentioned above.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an illustration of a lens holder assembled with a lens group of an imaging camera in accordance with a first embodiment of the present invention.

FIG. 2 is an illustration of a shielding of the imaging camera if the first embodiment.

FIG. 3 is an illustration of the whole imaging camera.

FIG. 4 is a cross-sectional view of the imaging camera.

FIG. 5 is an illustration of the whole imaging camera in accordance with a second exemplary embodiment of the present invention.

FIG. 6 is a cross-sectional view of the imaging camera in the second embodiment.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby are only to explain the disclosure, not intended to limit the disclosure.

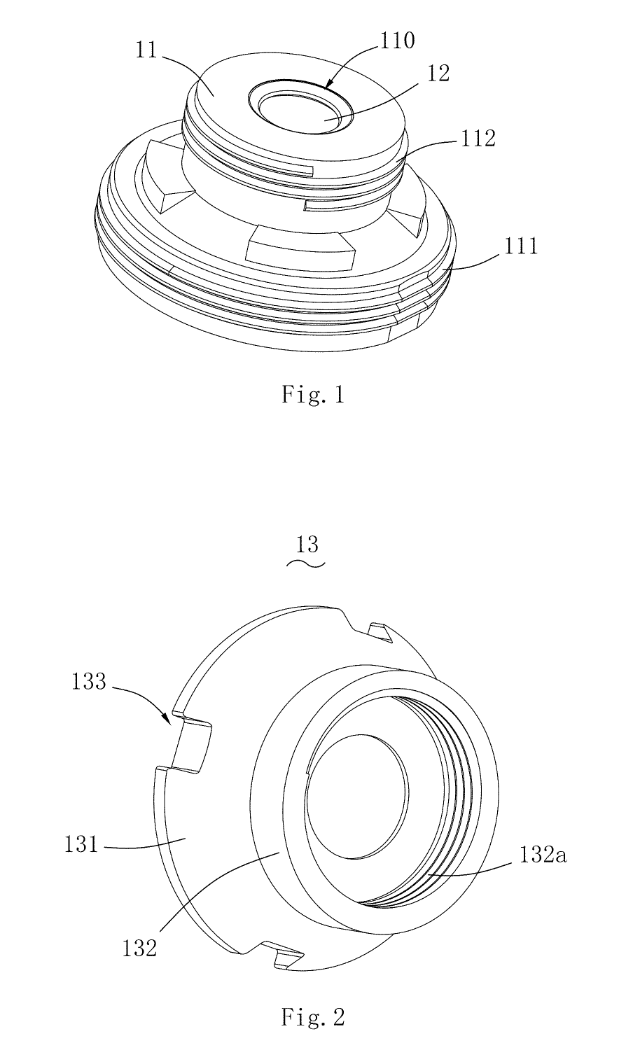

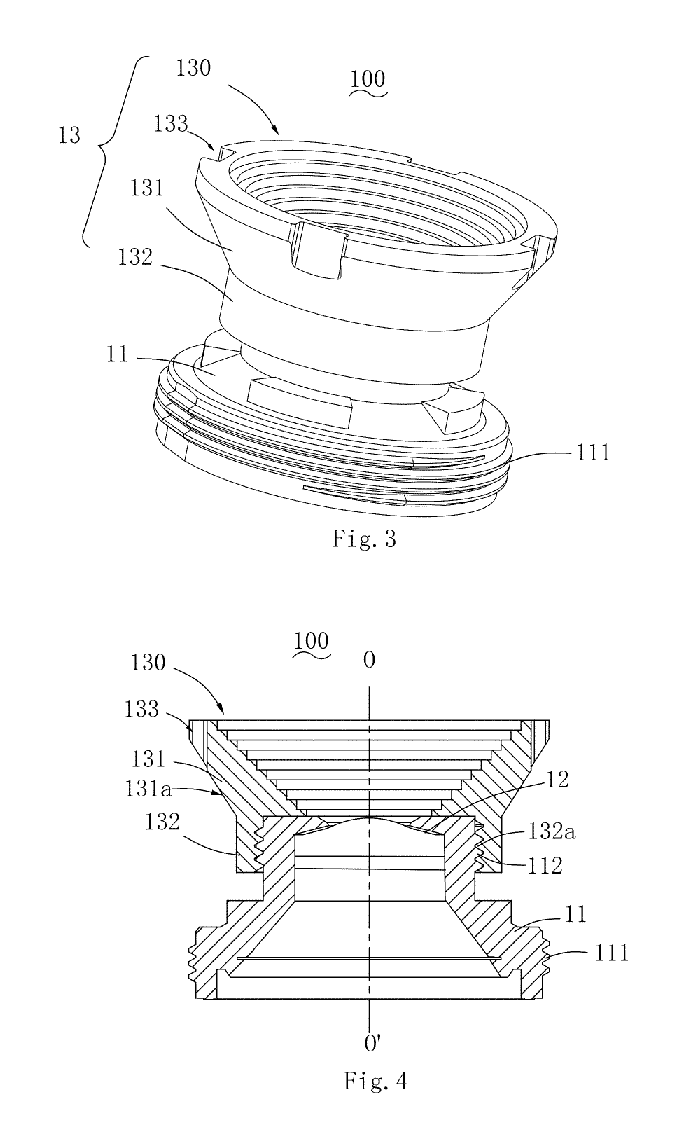

Referring to FIGS. 1-4, an imaging camera 100, in accordance with a first exemplary embodiment of the present invention, includes a lens holder 11, and a shielding 13. The lens holder 11 includes an aperture 110 and a receiving space 12 communicated with the aperture 110. The receiving space 12 is used for receiving a lens group. The shielding 13 is located at an object side of the lens holder 11 and connected to the lens holder 11. The shielding 13 is coaxial with the lens holder 11, and an optical axis OO′ is defined. The shielding 13 further includes an opening 130 with a diameter gradually reduced along a direction from the object side to an image side.

In the embodiment, the shielding 13 is arranged at the object side of the lens holder 11 and includes the opening communicated with the aperture 110. The opening's diameter is gradually reduced along the direction from the object side to the image side. Thus, the aperture 110 allows adequate incident light to enter the imaging camera 100, and meanwhile the shielding 13 blocks stray light by virtue of the opening 130 with the diameter gradually reduced, which improves the image quality. In addition, the shielding 13 located at the object side of the lens holder 11 can protect the lens group.

In this embodiment, the shielding 13 is separated from but connected with the lens holder 11. The lens holder 11 is used for providing a receiving space for accommodating the lens group. The lens group includes a plurality of lenses with a common optical axis.

The lens holder 11 includes threads 111 adjacent to the image side for mounting the image camera 100, thus the imaging camera 100 can be mounted with a voice coil motor or other component by the threads 111. In fact, other possible means for mounting the imaging camera is also feasible. The shielding 13 includes the opening 130 and a blocking part 131 for forming the opening 130, a connecting part connected with the blocking part 131, and a fastening part 133.

The opening a shoulder hole including a plurality of shoulders. The depth, height, and the amount of the shoulders can be designed or adjusted according to actual requirements. It should be noted that the shoulders can reflect the stray light back to the object. Therefore, stray light is reduced, and accordingly the image quality is improved. And, two perpendicular surfaces forming the shoulder are cooperatively workable to reflect stray light. In this embodiment, the opening 130 is a shoulder hole, however, as an alternative embodiment, the opening 130 could be a smooth hole.

As the opening 130 is coaxial with the aperture 110, the opening will not block the incident light to go through the aperture 110. Because the diameter of the opening reduces along the direction from the object side to the image side, the object side of the opening can mostly receive the incident light and block stray light. The blocking part 131 is used for forming the opening 130 and is fixed to the lens holder 11 by the connecting part 132.

One end of the connecting part 132 is connected to the blocking part 131, and the other end is fixed to the lens holder 11. In the present embodiment, the shielding 13 is mounted to the lens holder 11 by threads, also other possible assembly methods are feasible. Threads 132a (as shown in FIGS. 2-4) are arranged on the connecting part 132 at a part connecting with the lens holder 11, and the lens holder 11 correspondingly incudes threads 112.

The shielding 13 further includes a fastening part 133 for being beneficial to mount the shielding 13. The fastening part 133 could be a notch, a recess. The notch is arranged away from the lens holder 11. Preferably, the amount of the notch is four. The fastening part 133 makes it convenient to mount the shielding 13 with the lens holder 11, and also makes it convenient to assemble the imaging camera 100 with other component.

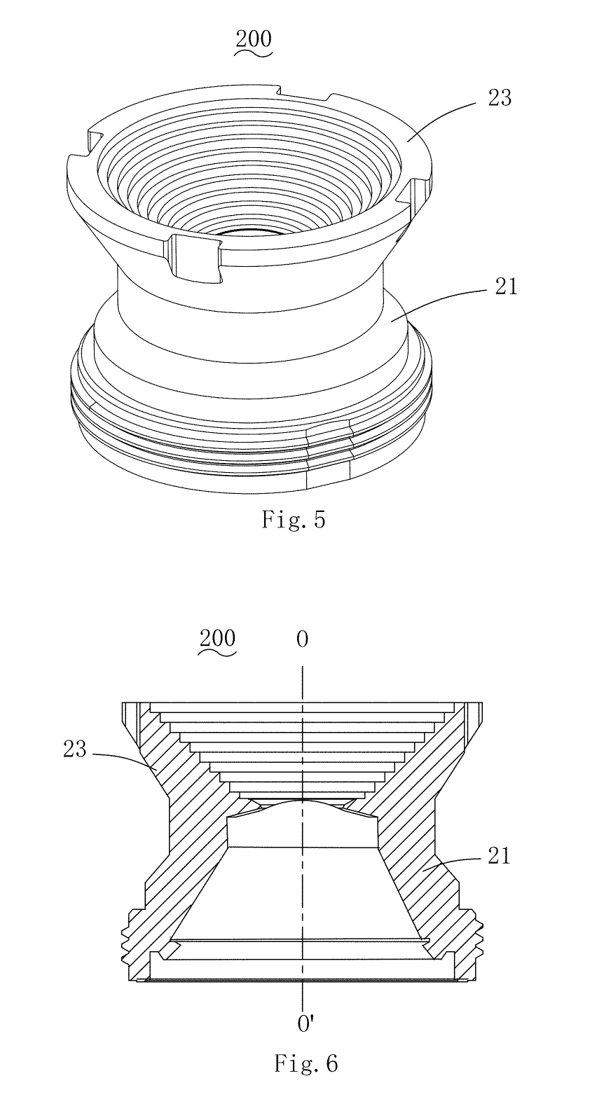

Referring to FIGS. 5-6, an imaging camera in accordance with a second exemplary embodiment of the present invention is disclosed. In this embodiment, the shielding 13 and the lens holder 11 is integral, which makes it more effective to manufacture the imaging camera 100.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An imaging camera, including:
a lens holder with an aperture;
a shielding located at an object side of the lens holder and connected to the lens holder, the shielding being coaxial with the lens holder; wherein
the shielding includes an opening communicated with the aperture, and the opening has a diameter gradually reduced along a direction from the object side to an image side.

2. The imaging camera as described in claim 1, wherein the opening is a shoulder hole.

3. The imaging camera as described in claim 2, wherein the shielding includes a connecting part fixed to the lens holder, and a blocking part extending from the connecting part toward the object side for forming the opening, and the blocking part is fixed to the lens holder by the connecting part.

4. The imaging camera as described in claim 3, wherein the connecting part includes threads at a part connecting with the lens holder, and the connecting part is assembled with the lens holder by the threads.

5. The imaging camera as described in claim 2, wherein the shielding is integral with the lens holder.

6. The imaging camera as described in claim 2, wherein the shielding includes a fastening part.

7. The imaging camera as described in claim 6, wherein the fastening part is a notch.

8. The imaging camera as described in claim 7, wherein the notch is arranged away from the lens holder.

9. The imaging camera as described in claim 1, wherein the lens holder includes threads at a part adjacent to the image side of the lens holder.
